(19) United States
(12) Patent Application Publication
(10) Pub. No.: US 2025/0063333 A1
(43) Pub. Date: Feb. 20, 2025

(54) METHOD AND APPRATUS FOR DISCOVERY PROCEDURE BETWEEN RELAY NODE AND SOURCE USER EQUIPMENT

(71) Applicant: MEDIATEK INC., Hsinchu City (TW)

(72) Inventors: Guan-Yu LIN, Hsinchu City (TW); Chia-Hao YU, Hsinchu City (TW); Lung-Sheng TSAI, Hsinchu City (TW); Nathan Edward TENNY, San Jose, CA (US)

(21) Appl. No.: 18/710,979

(22) PCT Filed: Jan. 10, 2023
(86) PCT No.: PCT/CN2023/071551

§ 371 Date: May 16, 2024

Related U.S. Application Data
(60) Provisional application No. 63/297,845, filed on Jan. 10, 2022.

(51) Int. Cl. H04W 8/00; H04W 8/24; H04W 88/04

(52) U.S. Cl. CPC H04W 8/005; H04W 8/24; H04W 88/04

(57) ABSTRACT

A synergetic communication method for discovery procedure between relay node and source user equipment (UE) is proposed. The network node may generate the resource configuration for discovery procedure and allocate the resource configuration for discovery procedure to a UE. The UE may transmit the resource configuration for discovery procedure to at least one relay node. Thus, the relay node is able to obtain the resource configuration for discovery procedure from the UE.

### CROSS REFERENCE TO RELATED APPLICATIONS

This application claims priority under 35 U.S.C. § 119 from U.S. Provisional Application No. 63/297,845, entitled “On Discovery between Source and Relay Nodes to support Synergetic UE Communication”, filed on Jan. 10, 2022, the subject matter of which is incorporated herein by reference.

### TECHNICAL FIELD

The disclosed embodiments relate generally to wireless communication, and, more particularly, to discovery procedure between relay node and source user equipment (UE) in mobile communications.

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3rd generation partner project (3GPP) network normally includes a hybrid of 2G/3G/4G systems. The next generation mobile network (NGMN) board, has decided to focus the future NGMN activities on defining the requirements for 5G new radio (NR) systems or 6G systems.

In conventional 5G technology, the relay communication via a relay node has the potential to modernize mobile communications for vehicles or other application scenarios. However, when the relay node is not able to directly obtain the resource configuration for the discovery procedure from the network node due to the limited capability of the relay node, e.g., the relay node is a layer 0 (L0) relay node or a layer 1 (L1) relay node, the relay node is not able to perform discovery procedure with the source UE.

A solution for discovery procedure is sought.

### SUMMARY

A synergetic communication method for discovery procedure between the relay node and the source UE is proposed. The network node may generate the resource configuration for discovery procedure and allocate the resource configuration for discovery procedure to a UE. In addition, the UE may transmit the resource configuration for discovery procedure to at least one relay node. Thus, the relay node is able to obtain the resource configuration for discovery procedure from the UE.

In one embodiment, a user equipment (UE) may receive a first resource configuration for a discovery procedure from a network node. The UE may transmit the first resource configuration for the discovery procedure from the network node to a relay node. In addition, the UE may perform the discovery procedure with the relay node.

In one embodiment, the UE may further receive a second resource configuration for a local communication from a network node, and perform the local communication with the relay node based on the second resource configuration in an event that at least one condition is met. The at least one condition comprises at least one of that an uplink (UL) carrier associated with the second resource configuration is out-of-range (OOC), a Reference Signal Received Power (RSRP) of a downlink (DL) carrier associated with the second resource configuration is smaller than a threshold, a transmission power of the UE is smaller than a threshold and the UE does not transmit on a specific beam direction.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary synergetic communication network in accordance with aspects of the current invention.

FIG. 2A is a schematic diagram of an aggregated group in accordance with one novel aspect.

FIG. 2B is a schematic diagram of an aggregated group in accordance with another novel aspect.

FIG. 2C is a schematic diagram of an aggregated group in accordance with another novel aspect.

FIG. 3 is a simplified block diagram of a network node and a user equipment that carry out certain embodiments of the present invention.

FIG. 4 illustrates a discovery procedure in accordance with one novel aspect.

FIG. 5 illustrates a discovery procedure in accordance with another novel aspect.

FIG. 6 is a flow chart of a discovery method in accordance with one novel aspect.

### DETAILED DESCRIPTION

Reference will now be made in detail to some embodiments of the invention, examples of which are illustrated in the accompanying drawings.

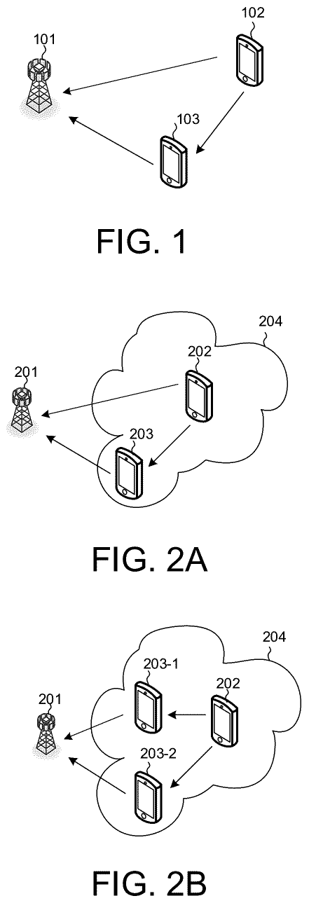

FIG. 1 illustrates an exemplary synergetic communication network in accordance with aspects of the current invention. The synergetic communication network comprises a network node 101, a user equipment (UE) 102 and at least one relay node 103. It should be noted that FIG. 1 only shows one relay node 103, but the invention should not be limited thereto. The synergetic communication network may comprise more than one relay node. The synergetic communication network may be applied to Sidelink (SL) communication or relay communication scenarios.

The network node 101 may be communicatively connected to the UE 102 operating in a licensed band (e.g., 30 GHz˜300 GHz for mm Wave) of an access network which provides radio access using a Radio Access Technology (RAT) (e.g., the 5G NR technology). The access network may be connected to a 5G core network by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy.

The network node 101 may be a base station (BS) or a gNB.

The UE 102 may be a smart phone, a wearable device, an Internet of Things (IoT) device, and a tablet, etc. Alternatively, UE 102 may be a Notebook (NB) or Personal Computer (PC) inserted or installed with a data card which includes a modem and RF transceiver(s) to provide the functionality of wireless communication.

The relay node 103 may be a layer 2 (L2) relay node, a layer 1 (L1) relay node or a layer 0 (L0) relay node.

L2 relay node may have capability of decoding the received packets to the level of L2 packets (i.e., in the unit of Medium-Access-Control Protocol-Data-Unit (MAC PDU), MAC Service Data Unit (SDU), RLC SDU, Radio Link Control (RLC) PDU, Packet Data Convergence Protocol (PDCP) SDU, or PDCP PDU), assembling the received L2 packets to form a new MAC PDU and forwarding the new MAC PDU to the next hop. That is to say, the L2 relay node may have similar functionalities as the UE 102. In L2 relay, a L2 relay node connects to the network before it transmits discovery message to announce itself as a L2 relay UE. During network connection establishment, a L2 relay node directly obtains the relay node identification (ID) from the network node 101 (same as legacy UE). That is, L2 relay node has capability to acquire its distinct network-recognizable ID (i.e., Cell-Radio Network Temporary Identifier (C-RNTI)) from the network directly.

L1 relay node may have functionalities between L0 relay node and L2 relay node. In an example, L1 relay node does not do L2 decoding for received control signaling and data which is to be forwarded to the network or other UE but is not for itself. In another example, the L1 relay node may support L2 decoding for its own control signaling, i.e. L1 relay node may be configured by L1 (e.g., Channel State Information (CSI) and/or Downlink Control Information, DCI) or L2 signaling (MAC Control Element (CE) or Radio Resource Control (RRC) configuration). L1 relay node may perform L1 procedure such as beam management, power control, or time slot specific on-off operation, which may follow the instruction of the received control signaling from the network. L1 relay node may not directly obtain the relay node identification (ID) from the network node 101, i.e., a L1 relay node may not have a UE ID (e.g., C-RNTI for network recognition) assigned by the network.

L0 relay node may only have the capability of amplifying and forwarding the received signal. L0 relay node may not directly obtain the relay node identification (ID) from the network node 101 (e.g., C-RNTI).

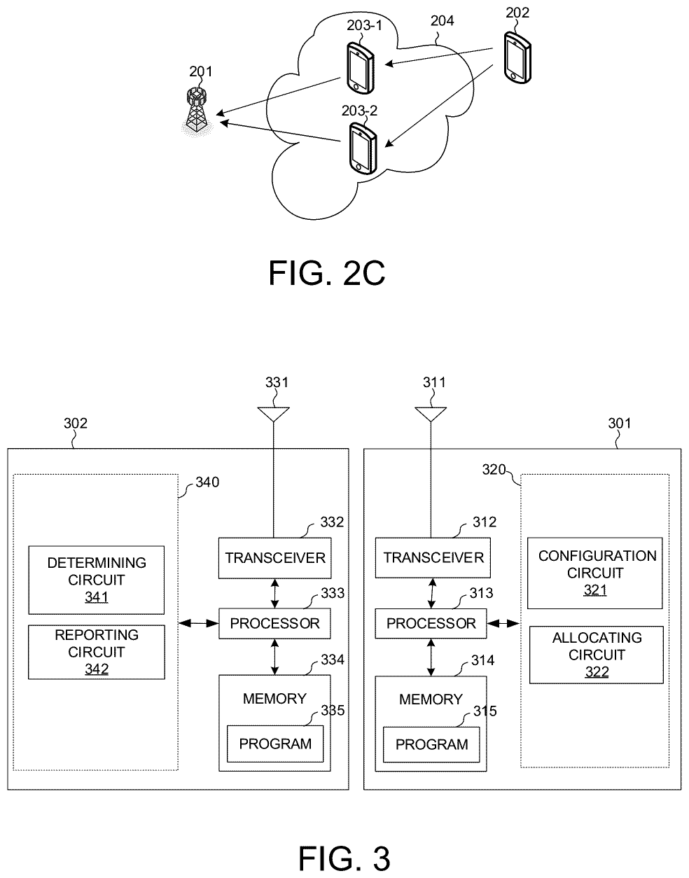

In accordance with one novel aspect, the UE 102 and the relay node(s) 103 may form an aggregated group. The UE 102 may coordinate the operations in the aggregated group. Taking FIG. 2A and FIG. 2B as examples. As shown in FIG. 2A, UE 202 and relay node 203 may form an aggregated group 204. As shown in FIG. 2B, UE 202, relay node 203-1 and relay node 203-2 may form an aggregated group 204. The type of aggregated group may be based on the type of the relay node(s) (e.g., the relay node is L2 relay node, L1 relay node or L0 relay node) in the aggregated group.

In accordance with another novel aspect, the relay nodes 103 may form an aggregated group, i.e., the aggregated group does not comprise the UE 102. In the aggregated group, a relay node 103 may be regarded as a master relay node (or relay node lead) which has better capability than other relay nodes 103 of the aggregated group, e.g., the master relay node is a L2 relay node and other relay nodes of the aggregated group are L1 relay nodes or L0 relay node. Taking FIG. 2C as an example. As shown in FIG. 2C, the aggregated group 204 may comprise the relay node 203-1 and relay node 203-2 and the relay node 203-1 is the master relay node. The master relay node may coordinate the operations in the aggregated group.

In accordance with a novel aspect, the UE 102 may receive a resource configuration for discovery procedure from the network node 101. Then, the UE 102 may transmit or broadcast the resource configuration for the discovery procedure to the relay node 103. After receiving the resource configuration for discovery procedure, the relay node 103 accordingly monitors the resource (or resource pool) for the discovery procedure, and the UE 102 may perform the discovery procedure with the relay node 103. After the discovery procedure between the UE 102 and the relay node 103 has been completed, the UE 102 may obtain the capability of the relay node 103 and report the capability of the relay node 103 and a joint capability of the relay node 103 and the UE 102 (i.e., a capability of the aggregated group) to the network node 101.

In accordance with a novel aspect, the relay node 103, if there is no resource configuration for discovery procedure, can transmit (e.g., broadcast) a request asking for the resource configuration. The UE 102 with a resource configuration for discovery procedure can respond with the request with resource configuration for discovery message.

In accordance with a novel aspect, the resource configuration for discovery procedure may be pre-configured by the network node 101. The network node 101 may broadcast the pre-configured resource configuration for discovery procedure or transmit system information block (SIB) with the pre-configured resource configuration for discovery procedure to the UE 102. The UE 102 may obtain the pre-configured resource configuration via the broadcast or the SIB from the network node 101. Then, the UE 102 may transmit or broadcast the pre-configured resource configuration for discovery procedure in an unlicensed band. In addition, the UE 102 may obtain the pre-configured resource configuration before leaving the coverage of the network node 101. In accordance with another novel aspect, the UE 102 may obtain the pre-configured resource configuration from subscriber identity module (SIM) default configuration.

In accordance with another novel aspect, the UE 102 may transmit a request for discovery procedure to the network node 101. Then, the network node 101 may transmit the resource configuration for discovery procedure to the UE 102 based on the request for discovery procedure. After the UE 102 obtains the resource configuration for discovery procedure, the UE 102 may transmit or broadcast the resource configuration for discovery procedure on an unlicensed band from the network node 101. In an example, the request for discovery procedure may comprise the information of the relay node 103, e.g., the type of the relay node.

In accordance with a novel aspect, when the relay node 103 is not able to directly obtain the resource configuration for discovery procedure from the network node 101, e.g., the relay node 103 is L0 relay node or L1 relay node, the relay node 103 may monitor an unlicensed band which is pre-configured to the relay node 103 for monitoring the resource (or resource pool) for discovery procedure. When the relay node 103 receives the resource configuration for discovery procedure from the UE 102 on the unlicensed band, the relay node 103 may perform the discovery procedure with the UE 102 based on the monitored resource (or resource pool) in the resource configuration for discovery procedure. That is, the UE 102 and the relay node 103 May 20 transmit or receive the discovery messages on the resource (or resource pool) indicated in the resource configuration.

The UE 102 and the relay node 103 may perform the discovery procedure via a 3rd Generation Partnership Project (3GPP) link, e.g., using 3GPP Sidelink technique or a non-3GPP link, e.g., using discovery procedure in Wi-Fi or Bluetooth in unlicensed band. In accordance with a novel aspect, when the UE 102 and the relay node 103 perform the discovery procedure via the 3GPP link, the UE 102 may perform the discovery procedure via an existing protocol stack (e.g., the protocol stack for NR SL discovery procedure) or a simplified protocol stack (e.g., the protocol stack for discovery procedure resides in layer 2, not in higher layer).

In accordance with a novel aspect, when the UE 102 is not able to directly transmit data to the network node 101 (e.g., the scenario of FIG. 2B), the UE 102 may transmit a set up message (e.g., RRCSetupRequest) to the network node 101 via the relay node 103 after the discovery procedure between the UE 102 and the relay node 103 has been completed. In an example, the set up message may be transmitted in random access channel (RACH) procedure. For instance, after discovery procedure, the relay node 103 may forward (e.g., repeating by amplify-and-forward) the transmission from the UE 102 in uplink (UL) and do the same in downlink (DL) for forwarding the set up message to the UE 102. In an example, the UE 102 may still receive synchronization signal from a reference point, so that the transmission or reception of the UE 102 is able to be performed based on the received synchronization. The reference point may be network node 101. The received synchronization signal may be directly or indirectly (e.g., relayed by the relay node 103) received by the UE 102.

In accordance with a novel aspect, the UE 102 may receive a resource configuration for local communication from the network node 101. Then, when the discovery procedure between the UE 102 and the relay node 103 has been completed, the UE 102 may perform the local communication with the relay node 103 based on the resource configuration for local communication when at least one of following conditions is met. The condition may comprise at least one of that an uplink (UL) carrier associated with the resource configuration for local communication is out-of-range (OOC), a Reference Signal Received Power (RSRP) of a downlink (DL) carrier associated with the resource configuration for local communication is smaller than a threshold, a transmission power of the UE 102 is smaller than a threshold and the UE 102 does not transmit on a specific beam direction.

In an example, the resource configuration for local communication may be pre-configured by the network node 101. In another example, the UE 102 may transmit a request for local communication to the network node 101, and then the network node 101 may transmit or grant the resource configuration for local communication to the UE 102 based on the request for local communication.

In accordance with a novel aspect, the request for local communication and the request for local communication may be the same request or different requests.

In accordance with a novel aspect, the UE 102 may transmit the request for local communication to the network node 101 before or after the UE 102 reports the information associated with the relay node 103. The information associated with the relay node may comprise at least one of the number of the relay nodes 103, identities of the UE 102 and the relay node 103, capability of the relay node 103 and a joint capability of the relay node 103 and the UE 102 (a capability of the aggregated group) to the network node 101.

FIG. 3 is a simplified block diagram of a network node and a user equipment (UE) that carry out certain embodiments of the present invention. The network node 301 may be a base station (BS) or a gNB, but the present invention should not be limited thereto. The UE 302 may be a smart phone, a wearable device, an Internet of Things (IoT) device, and a tablet, etc. Alternatively, UE 302 may be a Notebook (NB) or Personal Computer (PC) inserted or installed with a data card which includes a modem and RF transceiver(s) to provide the functionality of wireless communication.

Network node 301 has an antenna array 311 having multiple antenna elements that transmits and receives radio signals, one or more RF transceiver modules 312, coupled with the antenna array 311, receives RF signals from antenna array 311, converts them to baseband signal, and sends them to processor 313. RF transceiver 312 also converts received baseband signals from processor 313, converts them to RF signals, and sends out to antenna array 311. Processor 313 processes the received baseband signals and invokes different functional modules 320 to perform features in network node 301. Memory 314 stores program instructions and data 315 to control the operations of network node 301. Network node 301 also includes multiple function modules that carry out different tasks in accordance with embodiments of the current invention.

Similarly, UE 302 has an antenna array 331, which transmits and receives radio signals. A RF transceiver 332, coupled with the antenna, receives RF signals from antenna array 331, converts them to baseband signals and sends them to processor 333. RF transceiver 332 also converts received baseband signals from processor 333, converts them to RF signals, and sends out to antenna array 331. Processor 333 processes the received baseband signals and invokes different functional modules 340 to perform features in UE 302. Memory 334 stores program instructions and data 335 to control the operations of UE 302. UE 302 also includes multiple function modules and circuits that carry out different tasks in accordance with embodiments of the current invention.

The functional modules and circuits 320 and 340 can be implemented and configured by hardware, firmware, software, and any combination thereof. The function modules and circuits 320 and 340, when executed by the processors 313 and 333 (e.g., via executing program codes 315 and 335), allow network node 301 and UE 302 to perform embodiments of the present invention.

In the example of FIG. 3, the network node 301 may comprise a configuration circuit 321 and an allocating circuit 322. Configuration circuit 321 may generate the resource configuration for discovery procedure and the resource configuration for local communication. In an example, the resource configuration for discovery procedure and the resource configuration for local communication may be pre-configured by the configuration circuit 321. In another example, the resource configuration for discovery procedure and the resource configuration for local communication may be configured based on at least one request from the UE 302. Allocating circuit 322 may allocate the resource configuration for discovery procedure and the resource configuration for local communication to the UE 302.

In the example of FIG. 3, the UE 302 may comprise a determining circuit 341 and a reporting circuit 342. Determining circuit 341 may determine the resource (or resource pool) for discovery procedure based on the resource configuration for discovery procedure from the network node 301 and determine the resource (or resource pool) for local communication based on the resource configuration for local communication from the network node 301. Reporting circuit 342 may transmit the resource configuration for discovery procedure and the resource configuration for local communication to at least one relay node and reports the capability of the at least one relay node and a joint capability of the at least one relay node and the UE 302 (i.e., a capability of the aggregated group) to the network node 301.

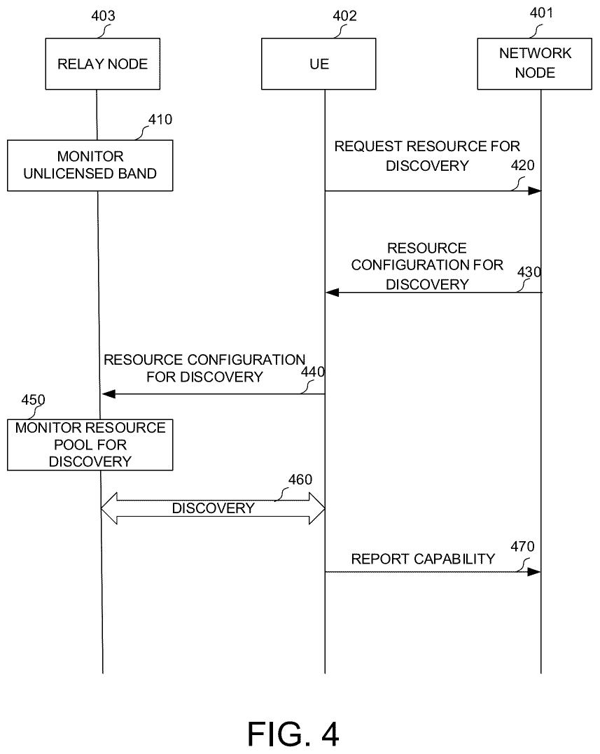

FIG. 4 illustrates a discovery procedure in accordance with one novel aspect. In step 410, the relay node 403 may monitor an unlicensed band.

In step 420, the UE 402 may transmit a request for discovery to the network node 401.

In step 430, the network node 401 may transmit the resource configuration for discovery procedure to the UE 402 based on the request from the UE 402.

In step 440, the UE 402 may transmit or broadcast the resource configuration for discovery procedure from the network node 401.

In step 450, the relay node 403 monitors the resource (or resource pool) in the resource configuration for discovery procedure from the UE 402 on the unlicensed band.

In step 460, the UE 402 and the relay node 403 may perform discovery procedure on the resource (or resource pool) for discovery procedure.

In step 470, the UE 402 may report the capability of the relay node 403 and a joint capability of the relay node 403 and the UE 402 (i.e., a capability of the aggregated group) to the network node 401.

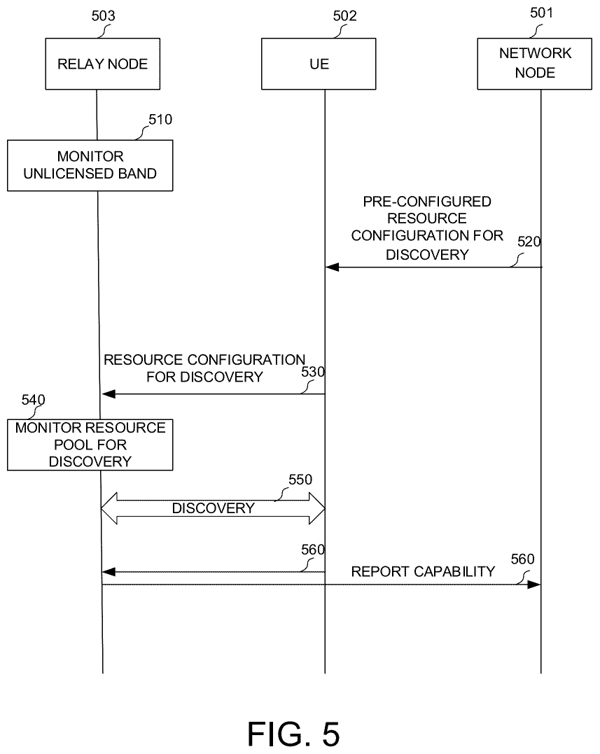

FIG. 5 illustrates a discovery procedure in accordance with another novel aspect. In step 510, the relay node 503 may monitor an unlicensed band.

In step 520, the network node 401 may transmit or broadcast the pre-configured resource configuration for discovery procedure.

In step 530, the UE 502 may transmit or broadcast the received pre-configured resource configuration for discovery procedure from the network node 501.

In step 540, the relay node 503 monitors the resource (or resource pool) in the pre-configured resource configuration for discovery procedure from the UE 502 on the unlicensed band.

In step 550, the UE 502 and the relay node 503 may perform discovery procedure on the resource (or resource pool) for discovery procedure.

In step 560, the UE 502 may report the capability of the relay node 503 and a joint capability of the relay node 503 and the UE 502 (i.e., a capability of the aggregated group) to the network node 501 via the relay node 503.

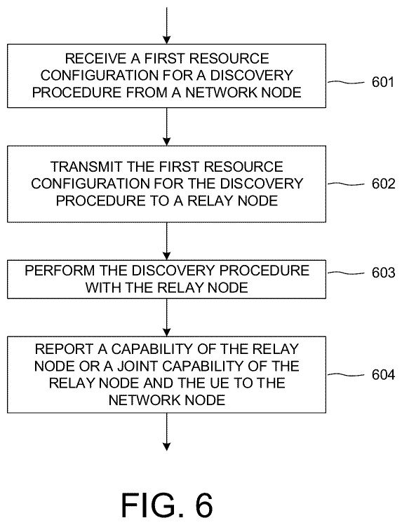

FIG. 6 is a flow chart of a discovery method in accordance with one novel aspect. In step 601, a user equipment (UE) receives a first resource configuration for a discovery procedure from a network node.

In step 602, the UE transmits the first resource configuration from the network node to a relay node.

In step 603, the UE performs the discovery procedure with the relay node.

In step 604, the UE reports a capability of the relay node or a joint capability of the relay node and the UE to the network node.

In accordance with a novel aspect, in the discovery method, the UE further receives a second resource configuration for a local communication from a network node, and performs the local communication with the relay node based on the second resource configuration in an event that at least one condition is met. The at least one condition comprises at least one of that an uplink (UL) carrier associated with the second resource configuration is out-of-range (OOC), a Reference Signal Received Power (RSRP) of a downlink (DL) carrier associated with the second resource configuration is smaller than a threshold, a transmission power of the UE is smaller than a threshold and the UE does not transmit on a specific beam direction.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving, by a user equipment (UE), a first resource configuration for a discovery procedure from a network node;
transmitting, by the UE, the first resource configuration for the discovery procedure from the network node to a relay node; and
performing, by the UE, the discovery procedure with the relay node.

2. The method of claim 1, further comprising:
reporting, by the UE, a capability of the relay node or a joint capability of the relay node and the UE to the network node.

3. The method of claim 1, further comprising:
transmitting, by the UE, a request for a discovery procedure to the network node before receiving the first resource configuration for the discovery procedure from the network node.

4. The method of claim 1, further comprising:
transmitting, by the UE, a set up message to the network node via the relay node.

5. The method of claim 1, wherein the performing comprises performing the discovery procedure via a 3rd Generation Partnership Project (3GPP) link or a non-3GPP link.

6. The method of claim 1, wherein the performing comprises performing the discovery procedure via an existing protocol stack or a simplified protocol stack.

7. The method of claim 1, further comprising:
receiving, a second resource configuration for a local communication from a network node; and
performing the local communication with the relay node based on the second resource configuration in an event that at least one condition is met.

8. The method of claim 7, wherein the at least one condition comprises at least one of that an uplink (UL) carrier associated with the second resource configuration is out-of-range (OOC), a Reference Signal Received Power (RSRP) of a downlink (DL) carrier associated with the second resource configuration is smaller than a threshold, a transmission power of the UE is smaller than a threshold and the UE does not transmit on a specific beam direction.

9. The method of claim 1, further comprising:
transmitting, by the UE, a request for a local communication to the network node; and
receiving, a second resource configuration for the local communication from the network node.

10. The method of claim 9, wherein the request for the local communication and a request for the discovery procedure are the same or different.

11. A user equipment (UE), comprising:
a receiver, receiving a first resource configuration for a discovery procedure from a network node;
a transmitter, transmitting the first resource configuration for the discovery procedure from the network node to a relay node; and
a processor, performing the discovery procedure with the relay node.

12. The UE of claim 11, wherein the transmitter reports a capability of the relay node or a joint capability of the relay node and the UE to the network node.

13. The method of claim 11, wherein the transmitter transmits, a request for a discovery procedure to the network node before receiving the first resource configuration for the discovery procedure from the network node.

14. The UE of claim 11, wherein the transmitter further transmits a set up message to the network node via the relay node.

15. The UE of claim 11, wherein the processor performs the discovery procedure via a 3rd Generation Partnership Project (3GPP) link or a non-3GPP link.

16. The UE of claim 11, wherein the processor performs the discovery procedure via an existing protocol stack or a simplified protocol stack.

17. The UE of claim 11, wherein the receiver further receives a second resource configuration for a local communication from a network node, and the processor performs the local communication with the relay node based on the second resource configuration in an event that at least one condition is met.

18. The UE of claim 17, wherein the at least one condition comprises at least one of that an uplink (UL) carrier associated with the second resource configuration is out-of-range (OOC), a Reference Signal Received Power (RSRP) of a downlink (DL) carrier associated with the second resource configuration is smaller than a threshold, a transmission power of the UE is smaller than a threshold and the UE does not transmit on a specific beam direction.

19. The UE of claim 11, wherein the transmitter further transmits a request for a local communication to the network node, and the receiver receives a second resource configuration for the local communication from the network node.

20. The UE of claim 19, wherein the request for the local communication and a request for the discovery procedure are the same or different.
